(19) United States
(12) Patent Application Publication
(10) Pub. No.: US 2025/0373343 A1
(43) Pub. Date: Dec. 4, 2025

(54) DYNAMIC RFI SUPPRESSION FOR COMMUNICATION PROTOCOLS

(71) Applicant: TEXAS INSTRUMENTS INCORPORATED, Dallas, TX (US)

(72) Inventors: Raghu GANESAN, Bangalore (IN); Naveen PRATHIPATI, Krishna District (IN); Saravanakkumar RADHAKRISHNAN, Aruppukottai (IN); Kalpesh Laxmanbhai RAJAI, Bangalore (IN)

(21) Appl. No.: 19/223,353

(22) Filed: May 30, 2025

(30) Foreign Application Priority Data
Jun. 3, 2024 (IN) 202441042915

(51) Int. Cl. H04B 15/02; H04L 27/26; H04W 76/10

(52) U.S. Cl. CPC H04B 15/02; H04L 27/265; H04W 76/10

(57) ABSTRACT

In an embodiment, a method includes: determining a bin corresponding to a radio frequency interference (RFI) spur in a signal, the bin based on a first sampling frequency of a timing loop in a receiver; determining a shift of the first sampling frequency to a second sampling frequency; updating the bin based on the shift; setting a filter coefficient of a notch filter based on the updated bin; suppressing the RFI spur using the notch filter, and establishing link-up between the receiver and another device after suppressing the RFI spur.

### CROSS-REFERENCE TO RELATED APPLICATIONS

The present application claims priority to India Provisional Patent Application No. 202441042915, which was filed Jun. 3, 2024, is titled “METHODS FOR RFI DETECTION AND CANCELLATION DURING ETHERNET PHY TRAINING,” and is hereby incorporated herein by reference in its entirety.

### TECHNICAL FIELD OF THE INVENTION

The present disclosure relates generally to an electronic system and method, and, in particular embodiments, to dynamic radio frequency interference (RFI) suppression for communication protocols.

### BACKGROUND

Ethernet is a family of networking technologies that transmits data over physical media within various network types. The Ethernet standard defines protocols and specifications for the physical layer and data link layer of the Open Systems Interconnection (OSI) model, including electrical signaling methods, frame formats, hardware addressing, and medium access control (MAC) procedures. Ethernet systems operate over copper cables, optical fiber, or wireless communication links, using defined data transmission rates and line encoding techniques. The Ethernet protocol includes functions for error detection, collision management, and support for full-duplex and half-duplex communication modes. Ethernet is defined by the Institute of Electrical and Electronics Engineers (IEEE) standard 802.3 and supports a range of network speeds and topologies.

### SUMMARY

In accordance to an embodiment, a method including: determining a bin corresponding to a radio frequency interference (RFI) spur in a signal, the bin based on a first sampling frequency of a timing loop in a receiver; determining a shift of the first sampling frequency to a second sampling frequency; updating the bin based on the shift; setting a filter coefficient of a notch filter based on the updated bin; suppressing the RFI spur using the notch filter; and establishing link-up between the receiver and another device after suppressing the RFI spur.

In accordance to an embodiment, a method, including: setting a timing loop of an receiver to a first sampling frequency; determining a first bin of a first radio frequency interference (RFI) spur after setting the timing loop to the first sampling frequency; setting the timing loop of the receiver to a second sampling frequency; determining a second bin of a second RFI spur after setting the timing loop to the second sampling frequency; determining a frequency band of the second RFI spur based on a difference between the first and second bins; updating the second bin based on a shift in sampling frequency of the receiver; setting a filter coefficient of a notch filter based on the updated second bin; and suppressing the second RFI spur using the notch filter.

In accordance to an embodiment, an apparatus including: a transceiver capable of: determining a bin corresponding to a radio frequency interference (RFI) spur in a signal; characterizing a frequency drift corresponding to the RFI spur; updating the bin based on the characterization; setting a filter coefficient of a notch filter based on the updated bin; and suppressing the RFI spur using the notch filter.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a block diagram of an electronic system including an Ethernet receiver capable of dynamic radio frequency interference (RFI) spur suppression during Ethernet physical layer (PHY) training, in accordance with various examples;

FIG. 2 is a schematic diagram of an Ethernet receiver capable of dynamic RFI spur suppression during Ethernet PHY training, in accordance with various examples;

FIG. 3 is a block diagram of a portion of an Ethernet receiver capable of dynamic RFI spur suppression during Ethernet PHY training, in accordance with various examples;

FIG. 4 is a block diagram of a portion of an Ethernet receiver capable of dynamic RFI spur suppression during Ethernet PHY training, in accordance with various examples;

FIG. 5 is a schematic diagram of a portion of an Ethernet receiver capable of dynamic RFI spur suppression during Ethernet PHY training, in accordance with various examples;

FIG. 6 is a schematic diagram of a portion of an Ethernet receiver capable of dynamic RFI spur suppression during Ethernet PHY training, in accordance with various examples;

FIG. 7 is a state diagram depicting the operation of an Ethernet receiver capable of dynamic RFI spur suppression during Ethernet PHY training, in accordance with various examples;

FIG. 8 is a flow diagram of the operation of an Ethernet receiver capable of dynamic RFI spur suppression during Ethernet PHY training, in accordance with various examples;

FIG. 9 is a flow diagram of the operation of an Ethernet receiver capable of dynamic RFI spur suppression during Ethernet PHY training, in accordance with various examples;

FIG. 10 is a graph depicting the operation of an Ethernet receiver capable of dynamic RFI spur suppression during Ethernet PHY training, in accordance with various examples;

FIG. 11 is a graph depicting the operation of an Ethernet receiver capable of dynamic RFI spur suppression during Ethernet PHY training, in accordance with various examples;

FIG. 12 is a graph depicting the operation of an Ethernet receiver capable of dynamic RFI spur suppression during Ethernet PHY training, in accordance with various examples; and

FIG. 13 is a flow diagram depicting the operation of an Ethernet receiver capable of dynamic RFI spur suppression during Ethernet PHY training, in accordance with various examples.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the examples disclosed are described in detail below. The present disclosure provides many applicable inventive concepts that can be embodied in a wide variety of specific contexts. The specific examples described are merely illustrative of specific ways to make and use the invention(s), and do not limit the scope of the invention(s).

The description below illustrates the various specific details to provide an in-depth understanding of several examples according to the description. The examples may be obtained without one or more of the specific details, or with other methods, components, materials and the like. In other cases, known structures, materials or operations are not shown or described in detail so as not to obscure the different aspects of the examples. References to “an example” in this description indicate that a particular configuration, structure or feature described in relation to the example is included in at least one example. Consequently, phrases such as “in one example” that may appear at different points of the present description do not necessarily refer exactly to the same example. Furthermore, specific formations, structures or features may be combined in any appropriate manner in one or more examples.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Some embodiments relate to Ethernet communication techniques, and more particularly, to radio frequency interference cancellation in Ethernet communications.

Ethernet is useful in a wide range of applications. Generally, Ethernet implementations are expected to provide high reliability, even in challenging conditions. For example, Ethernet is frequently implemented in safety and infotainment features in vehicles, aircraft, and spacecraft and must perform with a high degree of reliability despite radio frequency interference (RFI) that may originate from switching power electronics, electric motors and controllers, ignition systems, wireless systems in the vehicle (e.g., Bluetooth, cellular, Wi-Fi), and so on.

Ethernet communications occur between transmitter and receiver devices. To establish communication between a transmitter and a receiver, these devices go through a training process that culminates in link-up. Ethernet training and link-up refer to the initial process by which two Ethernet devices establish a communication link. During this phase, the devices exchange predefined signals to detect each other, synchronize timing, and adjust internal parameters such as equalization and echo cancellation. This ensures that the Ethernet physical layer is properly configured to transmit and receive data reliably over the specific cable and particular channel conditions. Once training is complete and the link is stable, normal data communication between the transmitter and receiver can begin.

The training process may include a range of steps, such as equalization and echo cancellation. The training process results in a more robust link-up when no RFI is present. However, the presence of RFI during the training process can affect the accuracy of the training process, resulting in failure to achieve link-up, or a link-up that takes a long time (e.g., 100 milliseconds or more), which may be unacceptable in many applications, such as automotive applications. More particularly, Ethernet hardware such as receiver hardware includes multiple adaptive loops (e.g., timing recovery loop, echo canceller, decision feedback equalizer, feed-forward equalizer) that converge toward a specific operational state during the training process. This convergence occurs as a result of multiple slicer decisions that occur during training. However, RFI affects the slicer decisions, and thus significant RFI can skew slicer decisions, which, in turn, may negatively impact training. A poor training session may result in link-up failure, or an unacceptably long link-up time.

In most or all cases, RFI is present during training and is not mitigated until after training is complete, resulting in the technical challenges described above. If RFI were mitigated during the training process, the technical challenges above would be mitigated or eliminated. However, mitigating RFI concurrently with the training process poses a number of technical challenges.

A first such challenge is that, during Ethernet link training, detection of RFI must occur while the communication channel is actively carrying Ethernet data signaling. In the case of 1000BASE-T1, the signal uses PAM-2 modulation, and in 100BASE-T1, the signal uses PAM-3modulation. These signaling schemes result in relatively high peak-to-peak voltage levels, such as 2 volts peak-to-peak (Vp-p) in 100BASE-T1, while the interfering RFI signals can be significantly lower in amplitude, such as 0.5 Vp-p or less. This results in a negative interference-to-signal ratio (ISR), making interference less distinguishable in the presence of the primary Ethernet waveform. Detection of RFI under these conditions typically relies on fast Fourier transform (FFT) analysis to identify narrowband spurious signals across the frequency spectrum. However, to detect low-amplitude interference, such as 100 millivolts peak-to-peak (mVp-p) spurs, multiple FFT windows may be averaged to reduce noise and increase sensitivity. But high-resolution FFT with averaging can require additional processing time or hardware resources, particularly when attempting to cover the full RFI frequency range. If the system reuses FFT processing blocks with limited computational capacity, longer durations are required to complete the analysis. This extended detection time reduces the available margin within the timing constraints for link-up, potentially impacting compliance with link establishment specifications.

A second challenge with mitigating RFI during training is that FFT-based detection of RFI during training is limited by the non-uniformity of the FFT noise floor across the frequency spectrum. The Ethernet signal received during training is affected by frequency-dependent shaping introduced by the analog front end (AFE) hardware and the physical transmission medium, such as Ethernet cables. The receiver AFE includes high-pass and low-pass filters, and the cable exhibits insertion loss that varies with frequency, resulting in a non-flat power spectral density for the received signal. These factors cause the baseline noise level—i.e., the noise floor—in the FFT domain to vary across frequencies. In certain frequency ranges, particularly at higher frequencies, the noise floor can exceed the amplitude of RFI spurs, making RFI spurs difficult to detect using simple peak detection methods. Because the background signal energy is not uniform, a fixed threshold approach may not reliably differentiate interference components from the shaped Ethernet signal and associated noise. As a result, RFI detection in such conditions requires more complex processing methods capable of accounting for the spectral characteristics of the system and the channel.

A third challenge arises from the fact that during Ethernet training, the digital signal processor (DSP) adjusts its internal clock to synchronize with the incoming data rate. While this timing loop is still locking, the sampling rate changes slightly. As a result, the notch filter—designed to block interference at a specific frequency—shifts in frequency relative to the fixed-frequency interference (spur), because the filter operates in the DSP's clock domain. Although the spur itself does not move, the notch filter frequency can drift away from the spur frequency (e.g., as a result of the shift in clock frequency). When the notch filter no longer aligns with the spur, the interference is no longer attenuated and can disrupt the timing recovery process, potentially preventing the receiver from achieving clock lock. As described below, challenges in addition to those expressly described above also may arise when mitigating RFI during training.

Some embodiments relate to techniques to overcome some or all of the technical challenges described above and to successfully mitigate RFI during the Ethernet training process. In particular, some embodiments perform RFI spur identification and suppression by notch filtering during the training process, before the receiver feedback loops (e.g., timing loop) have converged to steady state values. As described above, however, the identification and suppression of RFI spurs during training can be challenging, because the sampling frequency of the timing loop has not converged to steady state, meaning that the clock of the Ethernet receiver has not yet locked to the clock of the Ethernet transmitter. Thus, the sampling frequency of the timing loop is changing during this training period. As a result, the frequency of the RFI spur may drift, moving the RFI spur out of the frequency range to which the notch filter applies. To mitigate this challenge, some embodiments dynamically update the notch filter coefficient by determining the degree to which the sampling frequency of the timing loop has shifted and adjusting the notch filter coefficient accordingly. In this way, as the RFI spur frequency drifts during the training period, the notch filter continues to filter the RFI spur. In some embodiments, this technique is effective for RFI spurs whose original frequencies prior to aliasing by the Ethernet receiver is in-band, i.e., spurs that are within the Ethernet frequency band on which communications are occurring between the Ethernet transmitter and receiver.

The drifting of the RFI spur, meaning the magnitude and direction of the drift, may depend on the original frequency band of the RFI spur. It may be challenging to determine this original frequency band of the RFI spur after receiver aliasing has occurred. Some embodiments implement of a differential bin technique, as described below, to determine the original frequency band to which the RFI spur belonged. The identification of this frequency band may be useful to determine how the notch filter coefficient is to be adjusted to account for RFI spur frequency drift and to continue filtering the RFI spur despite the drift.

Some embodiments include additional features that facilitate the identification and suppression of RFI spurs during the training process. For example, as described above, a noise floor that varies with frequency can mask RFI spurs because the noise floor may, in some frequency bins, exceed the amplitude of an RFI spur. Some embodiments may flatten the noise floor by applying offsets to individual bins across the frequency spectrum, thereby facilitating the rapid identification and suppression of RFI spurs. The examples described herein also include an RFI spur detection circuit capable of performing FFT calculations in parallel to facilitate the identification of RFI spurs, which significantly improves operational efficiency.

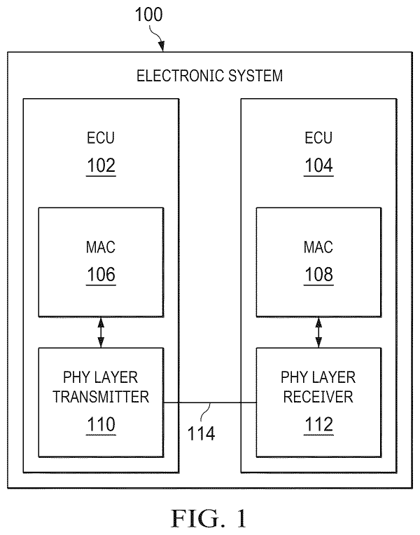

FIG. 1 is a block diagram of an electronic system including an Ethernet receiver capable of dynamic radio frequency interference (RFI) spur suppression during Ethernet physical layer (PHY) training, in accordance with various examples. In particular, FIG. 1 depicts an electronic system 100 that includes electronic control units (ECUs) 102 and 104, which, in turn, include media access control (MAC) layers 106 and 108, respectively. The ECU 102 includes a PHY layer transmitter (“transmitter”) 110, and the ECU 104 includes a PHY layer receiver (“receiver”) 112. The transmitter 110 interfaces with the MAC layer 106, and the receiver 112 interfaces with the MAC layer 108. The transmitter 110 and the receiver 112 are referred to herein as “transmitter” and “receiver” because the flow of data for purposes of description is assumed to be from the transmitter 110 to the receiver 112. In practice, the transmitter 110 and the receiver 112 may be transceivers permitting bidirectional data flow. In some embodiments, a cable 114 (e.g., a differential signal cable) couples the PHY layer transmitter 110 to the PHY layer receiver 112, as shown.

The electronic system 100 may be any type of apparatus or system in which Ethernet communications are implemented. Examples of the electronic system 100 include desktop computers, laptops, network switches, routers, wireless access points, printers, servers, storage arrays, smart televisions (TVs), game consoles, streaming devices, set-top boxes for home entertainment and connectivity, programmable logic controllers (PLCs), human-machine interfaces (HMIs), sensors, actuators, robotic systems, automotive infotainment systems, automotive cameras, radar units, VoIP phones, security cameras, medical imaging systems, telecommunications equipment, building automation controllers, and so on.

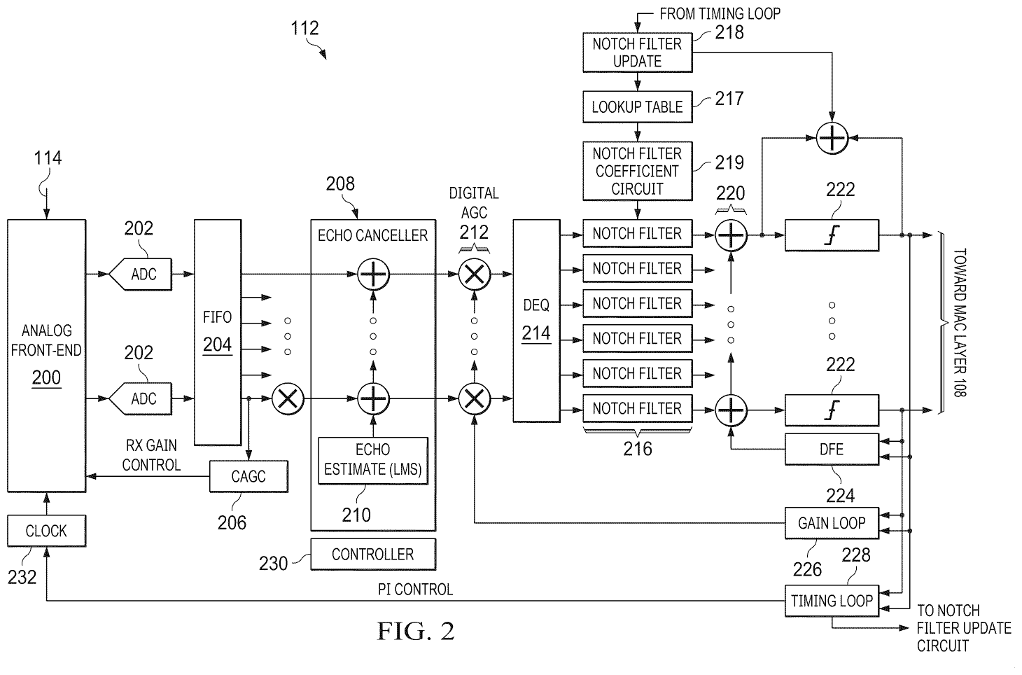

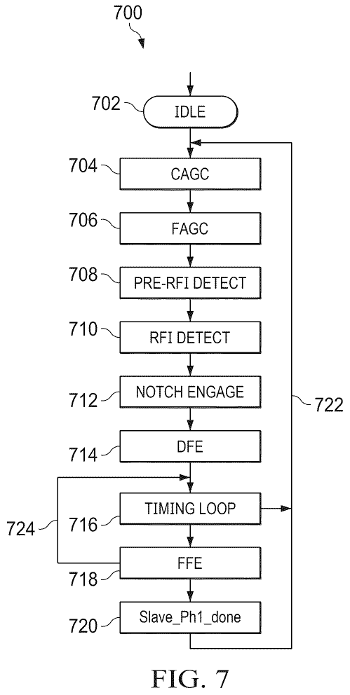

As described in detail below, the PHY layer 112, and more specifically, the receiver (or transceiver) implementing the PHY layer 112, is capable of dynamic RFI spur suppression during Ethernet PHY training. FIGS. 2-6 are now described to present the various structural components of the receiver 112, in accordance with various examples. FIGS. 7-13 are subsequently described to present the operation of the receiver 112, in accordance with various examples.

FIG. 2 is a schematic diagram of an Ethernet receiver capable of dynamic RFI spur suppression during Ethernet PHY training, in accordance with various examples. In particular, FIG. 2 depicts an example of the receiver 112, including analog front end (AFE) circuitry 200, analog-to-digital converters (ADCs) 202, a first-in, first-out (FIFO) buffer 204, a coarse automatic gain control (CAGC) circuit 206, an echo canceller circuit 208, an echo estimate circuit 210, a fine automatic gain control (FAGC) circuit 212, a digital equalizer (DEQ) circuit 214, notch filters 216, a lookup table (LUT) 217, a notch filter update circuit 218, a notch filter coefficient circuit 219, combination blocks 220, slicer circuits 222, a decision feedback equalizer circuit (DFE) 224, a gain loop circuit 226, a timing loop circuit 228, a controller 230, and a clock 232. The couplings between these various structures are as shown in FIG. 2. The AFE circuitry 200 is coupled to the cable 114, and the output of the receiver 112 is coupled to one or more structures implementing the MAC layer 108.

In some embodiments, controller 230 may be implemented as a generic or custom processor or controller coupled to a memory and configured to execute instructions stored in such memory. In some embodiments, controller 230 may be implemented using a field-programmable gate array (FPGA). In some embodiments, controller 230 includes a state machine. In some embodiments, controller 230 may include hardware accelerators. In some embodiments, controller 230 may be implemented without executing instructions stored in a memory. Other implementation are also possible.

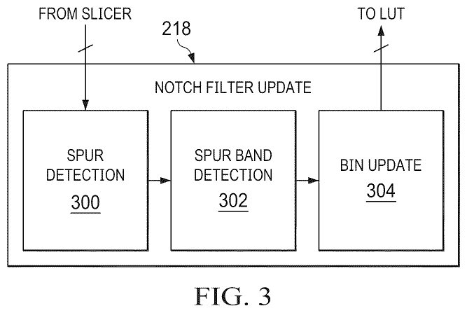

FIG. 3 is a block diagram of a portion of an Ethernet receiver capable of dynamic RFI spur suppression during Ethernet PHY training, in accordance with various examples. More particularly, FIG. 3 shows an example notch filter update circuit 218, which includes a spur detection circuit 300, a spur band detection circuit 302, and a bin update circuit 304. The inputs of the spur detection circuit 300 are coupled to the slicer circuits 222, and the outputs of the bin update circuit 304 are coupled to the notch filters 216 by way of the LUT 217 and the notch filter coefficient circuit 219.

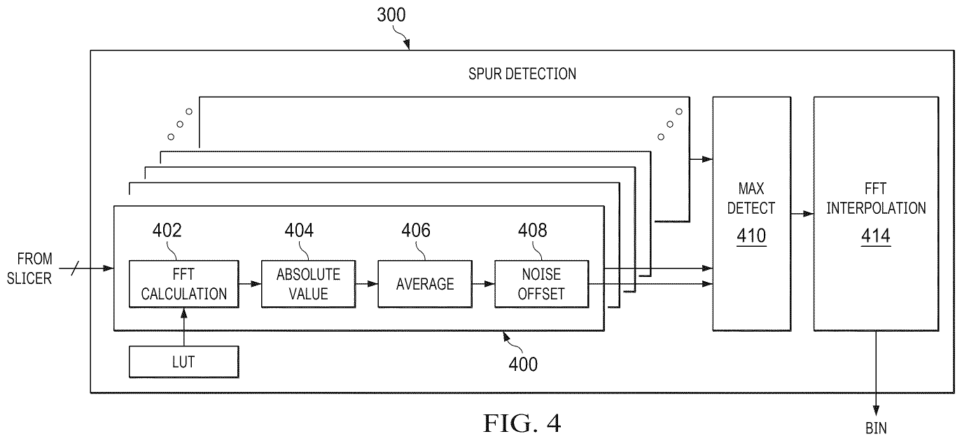

FIG. 4 is a block diagram of a portion of an Ethernet receiver capable of dynamic RFI spur suppression during Ethernet PHY training, in accordance with various examples. More particularly, FIG. 4 shows an example spur detection circuit 300, which includes multiple paths 400, each of the paths 400 including a Fast Fourier transform (FFT) calculation circuit 402, an absolute value circuit 404, an averaging circuit 406, and a noise offset circuit 408. The spur detection circuit 300 also includes a maximum detection circuit 410, a spur detection circuit 412, and an FFT interpolation circuit 414. The output of the FFT interpolation circuit 414, which is also the output of the spur detection circuit 300, provides a bin (synonymously referred to herein as a “bin value”).

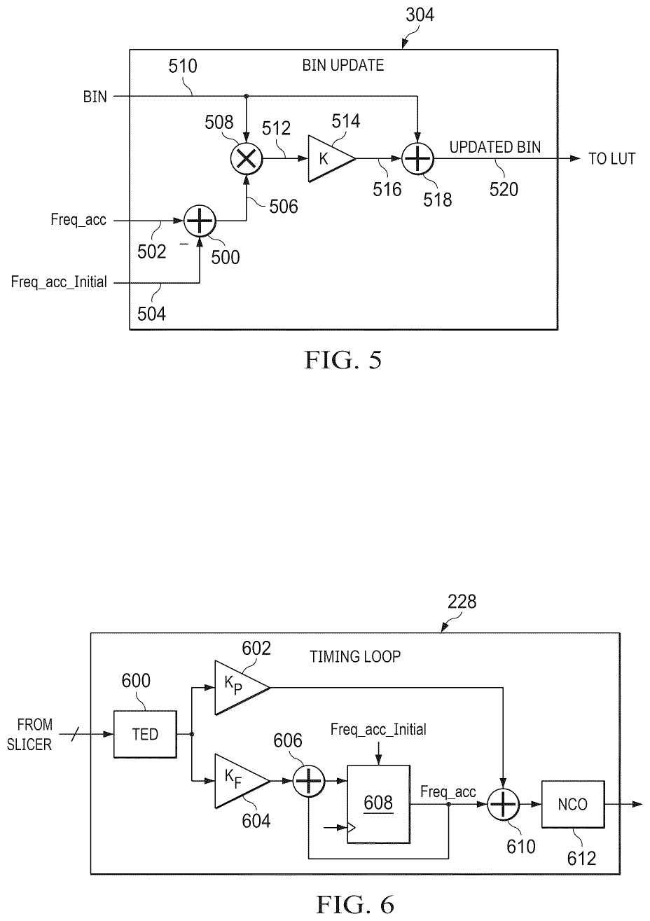

FIG. 5 is a schematic diagram of a portion of an Ethernet receiver capable of dynamic RFI spur suppression during Ethernet PHY training, in accordance with various examples. More specifically, FIG. 5 shows an example of the bin update circuit 304. The example bin update circuit 304 includes a combination block 500 coupled to connections 502 and 504 and to a connection 506; a multiplication block 508 coupled to connections 506, 510, and 512; a gain circuit 514 coupled to connections 512 and 516; and a combination block 518 coupled to connections 510, 516, and 520. The connection 510 is coupled to the output of the spur detection circuit 300 (FIG. 4). The connections 502 and 504 are coupled to the timing loop circuit 228 (FIG. 2), as described below. The connection 520 is coupled to the LUT 217 (FIG. 2).

FIG. 6 is a schematic diagram of a portion of an Ethernet receiver capable of dynamic RFI spur suppression during Ethernet PHY training, in accordance with various examples. In particular, the example timing loop circuit 228 includes a timing error detector (TED) circuit 600, a phase gain circuit 602, a frequency gain circuit 604, a combination block 606, a latch 608, a combination block 610, and a numerically-controlled oscillator (NCO) 612. The input to the TED 600 is coupled to the slicer circuits 222 (FIG. 2), and the output of the NCO 612 is coupled to the clock 232 (FIG. 2).

The Ethernet receiver 112, the components of which are depicted in and described with reference to FIGS. 1-6, operate to identify and suppress RFI spurs during the Ethernet training process, as described with reference to FIGS. 7-13. The descriptions of FIGS. 7-13 are provided with simultaneous reference to FIGS. 1-6.

In some embodiments, the methods illustrated in FIGS. 7-13 may be performed, at least in part, by controller 230. As an example, in some embodiments, controller 230 may include one or more (or all) of elements/blocks 204, 206, 208, 212, 214, 216, 218, 220, 222, 224, 226, and 228.

FIG. 7 is a state diagram depicting the operation of an Ethernet receiver capable of dynamic RFI spur suppression during Ethernet PHY training, in accordance with various examples. More specifically, FIG. 7 depicts at least part of the Ethernet PHY training process 700 during which the receiver 112 identifies and suppresses RFI spurs. The training process 700 includes an idle state 702. During the idle state 702, the transmitter 110 sends a repeated idle pattern or waveform to the receiver 112. This signal enables the receiver 112 to detect the presence of a valid link partner and begin clock and timing alignment.

The training process 700 includes a CAGC state 704. During the CAGC state 704, the AFE circuit 200 receives signals on the cable 114 (e.g., differential signals), and the ADCs 202 convert the signals from the analog domain to the digital domain. The ADCs 202 provide the digital signals to the FIFO buffer 204. The FIFO buffer 204 aggregates bits from the ADCs 202 and outputs multiple bits in parallel. The CAGC 206 receives one or more of these bits from the FIFO buffer 204. The CAGC 206 operates to control the gain applied to the analog signals in the AFE 200 based on the output of the FIFO buffer 204 to strengthen the analog signal (e.g., to increase the dynamic range while avoiding saturation). Applying gain to the analog signal in this manner mitigates the risk of clipping, as the cable 114 may attenuate the analog signal, particularly when the cable 114 is long. Thus, in effect, the CAGC 206 operates to control the gain applied to the analog signal by the AFE 200 to bring the signal amplitude to a usable range.

Although not expressly depicted as a distinct state in the training process 700, the echo canceller circuit 208 operates to mitigate reflections or echoes that appear on the transmitted signal received at the receiver 112 due to, e.g., impedance mismatches. The echo estimate circuit 210 provides an approximation of the echo to be cancelled to the echo canceller circuit 208, which, in turn, attenuates the aforementioned reflections or echoes in the bits output by the FIFO buffer 204.

The training process 700 includes the FAGC state 706. During the FAGC state 706, the FAGC circuit 212 applies small gain adjustments to the outputs of the echo canceller circuit 208 to maintain signal amplitude within a target range suitable for slicing operations, which are performed as described below.

Although not expressly depicted as a distinct state in the training process 700, the DEQ circuit 214 compensates for signal distortion caused by the transmission channel, particularly intersymbol interference (ISI) resulting from bandwidth limitations, reflections, or channel loss. The DEQ circuit 214 provides these equalized signals to the notch filters 216.

The training process 700 includes a pre-RFI detect state 708, an RFI detect state 710, and a notch engage state 712. Generally, and as described in greater detail below, during the RFI detect state 710, the slicer circuits 222 and the notch filter update circuit 218 identify RFI spurs in the output of the DEQ circuit 214.

During the notch engage state 712, the notch filter coefficients of the notch filters 216 are adjusted, and the notch filters 216 are applied to the output of the DEQ circuit 214. As also described below, the notch filter update circuit 218 is capable of dynamically updating the notch filter coefficients to compensate for RFI spur frequency drift caused by changes in the sampling frequency of the timing loop 228 during the training process, as the timing loop 228 converges toward steady state. However, the manner in which this compensation technique is applied depends on the frequency band to which the RFI spur belonged prior to aliasing by the receiver 112. Accordingly, during the pre-RFI detect state 708 and the RFI detect state 710, multiple frequency bin values are determined and used to identify the frequency band to which the RFI spur belonged prior to aliasing, and the identified frequency band determines the manner in which the compensation technique for RFI spur frequency drift is applied.

The specific manner in which states 708, 710, and 712 are applied is now described in accordance with some embodiments. To facilitate understanding, states 710 and 712 are first described while omitting state 708 as optional, and then states 708, 710, and 712 are described together.

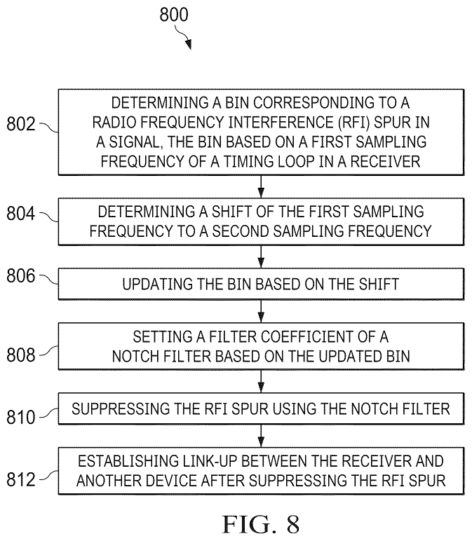

Assuming that state 708 is optional, the performance of states 710 and 712 is described by method 800 in FIG. 8. The method 800 includes determining a bin corresponding to an RFI spur in a signal (802), The bin is based on a first sampling frequency of a timing lop in a receiver (802). The receiver 112 identifies an RFI spur and a corresponding bin as follows. The notch filters 216 filter the output of the DEQ circuit 214 and provide the filtered outputs to combination blocks 220. The combination blocks 220 combine the filtered outputs with the output of the DFE circuit 224 to cancel ISI using prior slicer decisions in a feedback loop configuration. The slicer circuits 222 receive the outputs of the combination blocks 220. The slicer circuits 222 operate as comparators or quantizers, quantizing the inputs to a target scheme (e.g., pulse amplitude modulation (PAM)-3, meaning inputs are quantized to either −1, 0, or 1). The slicer circuits 222 may provide the quantized outputs to the MAC layer 108, as shown in FIG. 2. Additionally, however, the slicer circuits 222 determine the slicer error, meaning the difference between the inputs to the slicer circuits 222 and the respective outputs of the slicer circuits 222. This slicer error is provided to the notch filter update circuit 218 to be used to identify RFI spurs, and also to the DFE circuit 224, the gain loop circuit 226, and the timing loop circuit 228 to facilitate convergence of the loops toward steady state. Based on the slicer error, the DFE circuit 224 adjusts signals provided to the combination blocks 220 for ISI cancellation; the gain loop circuit 226 adjusts the gain applied by the FAGC circuit 212; and the timing loop circuit 228 adjusts the clock 232, which controls the sampling frequency by the AFE 200 and the ADCs 202.

The notch filter update circuit 218 receives the slicer errors. (In some examples, the notch filter update circuit 218 is capable of acquiring and using data from other points along the signal path of the receiver 112 in lieu of slicer errors.) The spur detection circuit 300 uses the slicer errors to identify the RFI spur frequency (in the event that multiple spurs are present, the technique described herein is repeated multiple times to suppress all identifiable spurs). The spur detection circuit 300 outputs a bin value that indicates the RFI spur frequency. The spur band detection circuit 302 is applicable only when the pre-RFI detect state 708 (FIG. 7) is enabled, and thus is described below.

The bin update circuit 304 updates the bin value provided by the spur detection circuit 300 to compensate for RFI spur frequency drift caused by changes in the sampling frequency of the timing loop circuit 228. The bin update circuit 304 updates the LUT 217, and the notch filter coefficient circuit 219 uses values from the LUT 217 to determine updated notch filter coefficients for the notch filters 216, thus enabling the notch filters to track and suppress drifting RFI spurs.

The spur detection circuit 300, and in particular the paths 400, receive the slicer error values from the slicer circuits 222. Any suitable numbers of paths 400 may be included, depending on a range of factors including operational efficiency, size, and manufacturing cost. In each path 400, the FFT calculation circuit 402 performs a coarse FFT, and absolute values of the resulting output are determined by the absolute value circuit 404. Accumulated absolute values are averaged by the averaging circuit 406. The noise offset circuit 408 may further improve the ability to identify RFI spurs by flattening a variable noise floor that may be present in the frequency spectrum, for example, a noise floor that varies in amplitude to such a degree that maximum noise floor amplitudes exceed RFI spur amplitudes, thus masking the presence of the RFI spurs.

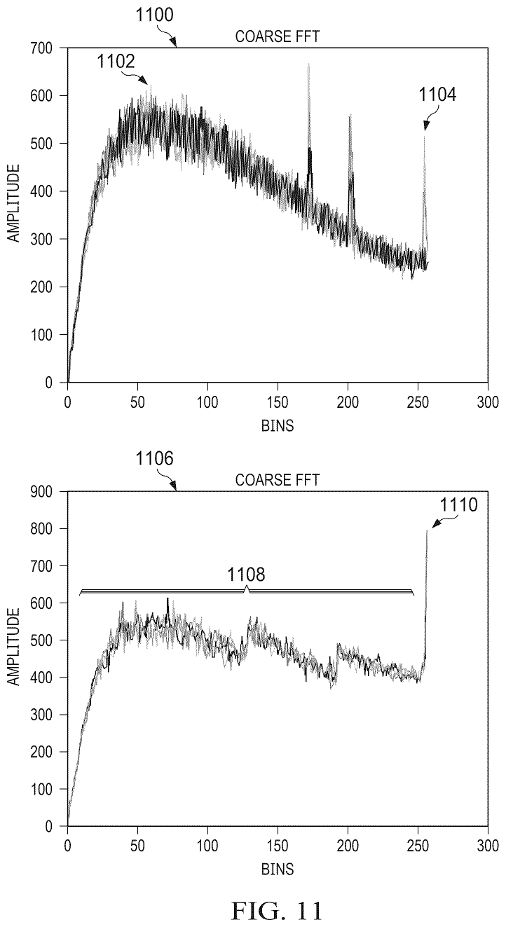

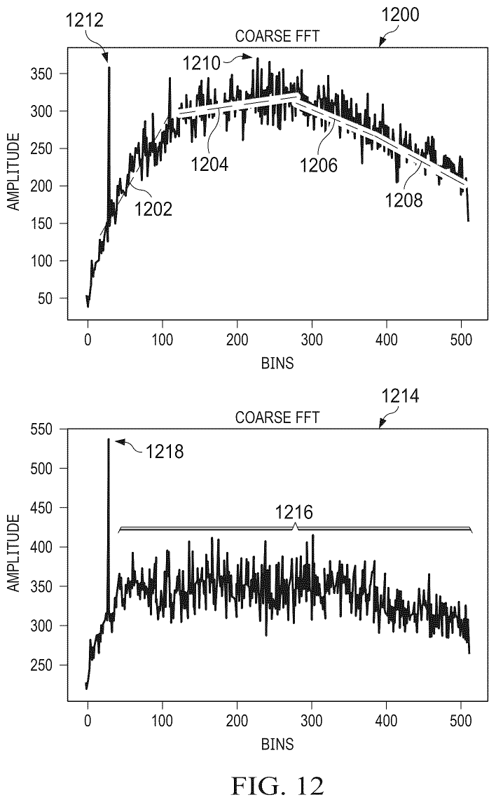

In some embodiments, the noise offset circuit 408 applies different offsets to different bin values in such a way that the noise floor is flattened. FIG. 11 depicts an example of such flattening. In graph 1100, the x-axis represents a range of bin values, and the y-axis represents amplitude. As shown, the noise floor varies significantly in graph 1100, such that a maximum noise floor amplitude 1102 exceeds an RFI spur value 1104. Thus, in any technique that uses the maximum amplitude value to identify RFI spurs, the noise floor amplitude 1102 will mask the RFI spur. After the noise offset circuit 408 manipulates the bin values to flatten the noise floor, the RFI spur is more readily identified, as graph 1106 shows. In graph 1106, the x-axis represents a range of bin values, and the y-axis represents amplitude. As shown, the noise floor 1108 is substantially flatter than in graph 1100, making the RFI spur value 1110 readily identifiable. In some examples, the noise offset circuit 408 may apply a segmented approach, as FIG. 12 shows.

FIG. 12 depicts a graph 1200 including lines 1202, 1204, 1206 and 1208, which approximate various segments of the noise floor. The maximum noise floor amplitude 1210 exceeds the RFI spur value 1212, thus masking the presence of the RFI spur. The noise offset circuit 408 may apply a same or similar offset to groups of bins, for example, the same offset value for all bins corresponding to the line 1202, another common offset value for all bins corresponding to the line 1204, and so on. The result is shown in graph 1214, in which the noise floor is flattened as numeral 1216 depicts, and the RFI spur value 1218 is readily identified.

Returning to the spur detection circuit 300, the outputs of the noise offset circuits 408 across all paths 400 are provided to the max detection circuit 410. The max detection circuit 410 identifies the bin with the maximum amplitude. In the example of graph 1106 in FIG. 11, the max detection circuit 410 may identify the RFI spur value 1110. In the example of graph 1214 in FIG. 12, the max detection circuit 410 may identify the RFI spur value 1218. Upon identification of a spur by the max detection circuit 410, the spur detection circuit 300 may perform one or more fine FFTs (e.g., re-using any portion of the paths 400) and/or may perform an FFT interpolation using the FFT interpolation circuit 414 to increase the resolution of the RFI spur frequency or bin. The FFT interpolation circuit 414 subsequently provides an output bin value to the spur band detection circuit 302 and/or to the bin update circuit 304.

The method 800 includes determining a shift of the first sampling frequency to a second sampling frequency (804) and updating the bin value based on the shift (806). As mentioned above, the spur band detection circuit 302 will be described further below. The bin update circuit 304 receives the bin value from the spur detection circuit 300 and updates the bin value to compensate for RFI spur frequency drift. In particular, the combination block 500 of the bin update circuit 304 determines a difference between an initial sampling frequency that was being used by the timing loop circuit 228 when the spur detection circuit 300 determined the bin value received on connection 510 from the spur detection circuit 300, and the current sampling frequency presently being used by the timing loop circuit 228. The initial sampling frequency is provided on connection 504, and the current sampling frequency is provided on connection 502. The combination block 500 determines a difference between these two frequencies and provides the difference on the connection 506. The multiplication block 508 multiplies the difference on connection 506 by the bin value on connection 510 to produce a product on connection 512. The gain circuit 514 applies a scaling factor K to the product on connection 512, where the scaling factor K represents a conversion ratio between the Freq_acc signal and a clock offset value that is the difference between Freq_acc and Freq_acc_initial, thereby modifying the bin value in tandem with changes to the sampling frequency. The output of the gain circuit 514 is provided on connection 516.

In some embodiments, the combination block 518 combines the signal on connection 516 with the bin value on connection 510 to produce an updated bin value on connection 520. The updated bin value is stored in the LUT 217 and may subsequently be used to update the appropriate notch filter coefficient(s) of the appropriate notch filter(s) 216 (808) by the notch filter coefficient circuit 219, thereby enabling the notch filters to track and suppress drifting RFI spur frequencies (810). Because even drifting RFI spur frequencies are suppressed by the notch filters 216, the RFI is mitigated, enabling the training process to successfully complete and for a robust link-up to be rapidly established (812).

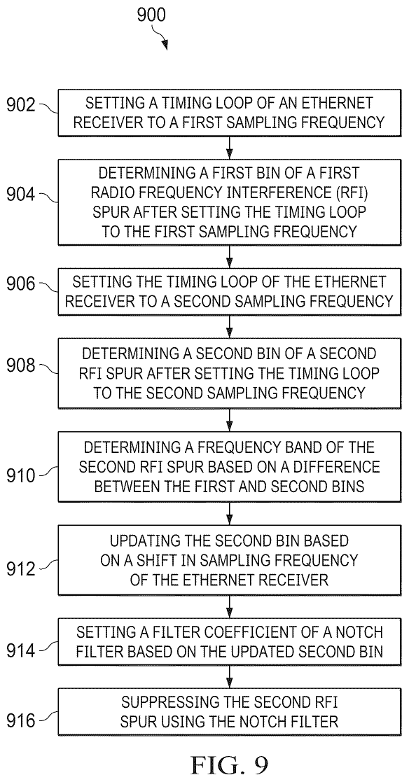

The foregoing description assumes that the pre-RFI detect state 708 is optional. However, in some cases, the pre-RFI detect state 708 is enabled. The pre-RFI detect state 708 may be enabled to achieve two separate RFI detections in states 708 and 710, which facilitates the identification of the original frequency band to which an RFI spur belonged prior to aliasing by the receiver 112. The method 900 of FIG. 9 describes the enablement of the pre-RFI state 708, the RFI state 710, and the notch engage state 712, and is now described.

The method 900 includes setting the timing loop of the Ethernet receiver to a first sampling frequency (902). The TED 600 of the timing loop circuit 228 receives slicer errors from the slicer circuits 222, and the TED 600 determines the timing misalignment between the current sampling frequency of the timing loop circuit 228 and the ideal sampling point. The TED 600 outputs have frequency and phase components. The gain circuit 602 applies gain to the phase component of the TED 600 output, and the gain circuit 604 applies gain to the frequency component of the TED 600 output. The latch 608 may be programmed with an initial sampling frequency Freq_acc_initial, which is output at Freq_acc. Freq_acc is fed back to the combination block 606, which modifies Freq_acc with the output of the gain circuit 604, to produce a new value for Freq_acc. This new value for Freq_acc is again latched in the latch 608, and the process repeats. In this way, the sampling frequency continuously changes, converging toward a steady state value based on the output from the TED 600. The Freq_acc signal is combined with the output of the gain circuit 602 at combination block 610, and the NCO 612 adjusts the frequency of the clock 232 accordingly. For example, the first sampling frequency of step 902 may be referred to herein as Freq_acc_initial_1. The method 900 includes determining a first bin of a first RFI spur after setting the timing loop circuit to the first sampling frequency (904). The spur detection circuit 300 determines this first bin value in the same manner as already described above.

The method 900 includes setting the timing loop circuit of the receiver to a second sampling frequency (906). For example, the second sampling frequency of step 906 may be referred to herein as Freq_acc_initial_2. The method 900 includes determining a second bin of a second RFI spur after setting the timing loop to the second sampling frequency (908). The second RFI spur is the same spur as the first RFI spur, but the frequencies to which the first and second RFI spurs correspond differ due to the changing symbol frequency. The spur detection circuit 300 determines this second bin value in the same manner as already described above. The method 900 includes determining a frequency band of the second RFI spur based on a difference between the first and second bin values (910). The spur band detection circuit 302 (FIG. 3) performs step 910 by receiving the first and second bin values from the spur detection circuit 300 and determining a difference between those bin values, and by determining which frequency band the second RFI spur corresponds to based on the difference.

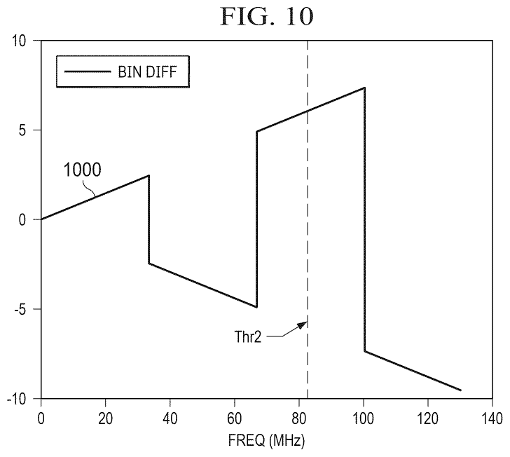

FIG. 10 depicts a graph with frequency in MHz on the x-axis and bin value difference on the y-axis. Curve 1000 shows an example variation of the difference in example bin values over a frequency spectrum. The graph also depicts a threshold frequency 1002 (e.g., a pre-programmed threshold frequency). If the spur band detection circuit 302 determines that the difference in the bin values calculated in step 910 is below the threshold frequency 1002 and is positive, the spur band detection circuit 302 concludes that the original frequency band of the second spur (prior to aliasing by the receiver 112) is a first band. If the spur band detection circuit 302 determines that the difference is below the threshold frequency 1002 and is negative, the original frequency band is a second band. If the difference is above the threshold frequency 1002 and is positive, the original frequency band is a third band, and if negative, then the original frequency band is a fourth band. Each of the first, second, third, and fourth bands corresponds to a different equation by which to calculate the change in bin value at connection 512 (FIG. 5). For example, if the spur band detection circuit 302 determines that the original frequency band of the RFI spur in question was the first band, the spur band detection circuit 302 provides the bin value from the spur detection circuit 300 to the connection 510 in the bin update circuit 304. However, if the spur band detection circuit 302 determines that the original frequency band was the second band, the spur band detection circuit 302 provides a modified bin value to the connection 510. Similarly, if the spur band detection circuit 302 determines that the original frequency band was the third or fourth band, the spur band detection circuit 302 provides other modified bin values to the connection 510.

In an example implementation where the original frequency of the RFI spur (prior to aliasing) may fall into one of three possible frequency bands, the spur band detection circuit 302 provides a bin value on connection 510 as follows:

$$- bin \qquad ( 1 )$$

for the first frequency band,

$${2}^{N} - bin \qquad ( 2 )$$

for the second frequency band, and

$$- ( {2}^{N} - bin ) \qquad ( 3 )$$

for the third frequency band, where 2^{N} is the size of the FFT implemented in the spur detection circuit 300.

In some embodiments, the method 900 includes updating the second bin based on the second bin, a shift in sampling frequency of the Ethernet receiver, and the frequency band (912). The bin update circuit 304 performs step 912 using a bin value at connection 510 that depends on the original frequency band of the RFI spur prior to aliasing (e.g., one of expressions (1)-(3)). The bin update circuit 304 may operate as already described above to provide the updated bin value at connection 520.

In some embodiments, the method 900 includes setting a notch filter coefficient based on the updated second bin (914) and suppressing the second RFI spur using the notch filter (916). The bin update circuit 304 uses the updated bin at connection 520 to update the LUT 217, and the updated LUT 217 is used to update the appropriate notch filter coefficient(s) of the notch filter(s) 216 by the notch filter coefficient circuit 219, which are then useful to suppress the RFI spur as described above.

Returning to the training process 700 (FIG. 7), after the notch filtering is performed (state 712), a DFE state 714 is enabled in which the DFE circuit 224 uses the slicer errors from the slicer circuits 222, which are operating on spur-suppressed outputs from the notch filters 216, to cancel ISI, as described above. In a timing loop state 716, the timing loop circuit 228 adjusts the frequency of the clock 232 based on the slicer errors from the slicer circuits 222, as described above. In a feed-forward equalizer (FFE) state 718, the DEQ circuit 214, which includes a finite impulse response (FIR) filter with adaptive coefficients, filters the outputs of the FAGC circuit 212 having the newly applied gain values as determined by the gain loop circuit 226. In state 720, the training phase is complete.

In some cases, if the bit error rate (BER) and/or the mean squared error (MSE) exceed particular thresholds, the training process 700 may restart at CAGC state 704, as indicated by numeral 722. Alternatively, if after state 718, the MSE exceeds a threshold, state 716 may be repeated, as numeral 724 indicates. In some examples, the states of the training process 700 may be performed in a different sequence than shown. In some examples, two or more of the states of the training process 700 may overlap with each other, meaning that the states are enabled concurrently.

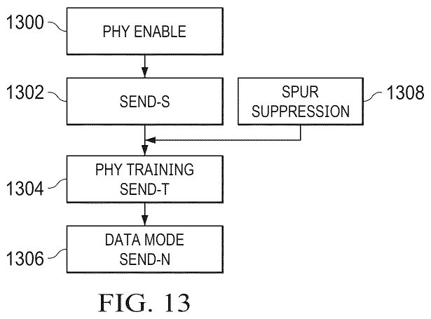

The foregoing description assumes that the RFI spur identification and suppression techniques are performed during the receiver training process. However, in some examples, the RFI spur identification and suppression techniques may be performed in the period of time (e.g., 1 millisecond) immediately prior to the training process. This period of time is otherwise unused by the Ethernet protocol and may be useful to identify and filter RFI spurs before the sampling frequency of the receiver 112 begins to shift during the training process. Referring to FIG. 13, after the PHY layers of the transmitter 110 and receiver 112 are enabled (FIG. 1) (1300), a SEND-S (send silence or send symmetric idle) state is enabled (1302), followed by a SEND-T (send training) state (1304), followed by a SEND-N (send normal) state (1306). In some embodiments, the gap between states 1302 and 1304 is approximately 1 millisecond, during which time spur identification and suppression (state 1308) using any or all combinations and variations of the techniques described herein may be used to identify and suppress RFI spurs. This technique may find particular utility in certain applications, e.g., automotive gigabit Ethernet (1000BT1).

In this description, unless otherwise stated, “about,” “approximately” or “substantially” preceding a parameter means being within +/−10 percent of that parameter. Modifications are possible in the described examples, and other examples are possible within the scope of the claims.

Example embodiments of the present disclosure are summarized here. Other embodiments can also be understood from the entirety of the specification and the claims filed herein.

Example 1. A method including: determining a bin corresponding to a radio frequency interference (RFI) spur in a signal, the bin based on a first sampling frequency of a timing loop in a receiver; determining a shift of the first sampling frequency to a second sampling frequency; updating the bin based on the shift; setting a filter coefficient of a notch filter based on the updated bin; suppressing the RFI spur using the notch filter; and establishing link-up between the receiver and another device after suppressing the RFI spur.

Example 2. The method of example 1, where suppressing the RFI spur includes suppressing the RFI spur during or prior to training the receiver.

Example 3. The method of one of examples 1 or 2, further including detecting the RFI spur by applying a Fast Fourier transform to the signal.

Example 4. The method of one of examples 1 to 3, where determining the bin includes applying a Fast Fourier transform to the signal.

Example 5. The method of one of examples 1 to 4, further including detecting the RFI spur during an interval between an idle state and a training state.

Example 6. The method of one of examples 1 to 5, further including adding an offset to reduce noise amplitude variation across a frequency spectrum and identifying the RFI spur after adding the offset.

Example 7. The method of one of examples 1 to 6, further including performing a slicing operation on the signal.

Example 8. The method of one of examples 1 to 7, where the receiver is an Ethernet receiver.

Example 9. A method, including: setting a timing loop of an receiver to a first sampling frequency; determining a first bin of a first radio frequency interference (RFI) spur after setting the timing loop to the first sampling frequency; setting the timing loop of the receiver to a second sampling frequency; determining a second bin of a second RFI spur after setting the timing loop to the second sampling frequency; determining a frequency band of the second RFI spur based on a difference between the first and second bins; updating the second bin based on a shift in sampling frequency of the receiver; setting a filter coefficient of a notch filter based on the updated second bin; and suppressing the second RFI spur using the notch filter.

Example 10. The method of example 9, further including updating the second bin using an equation corresponding to the frequency band.

Example 11. The method of one of examples 9 or 10, where determining the frequency band includes determining whether the difference is positive or negative and whether the difference exceeds a threshold.

Example 12. The method of one of examples 9 to 11, where updating the second bin includes using a Fast Fourier transform (FFT) size.

Example 13. An apparatus including: a transceiver capable of: determining a bin corresponding to a radio frequency interference (RFI) spur in a signal; characterizing a frequency drift corresponding to the RFI spur; updating the bin based on the characterization; setting a filter coefficient of a notch filter based on the updated bin; and suppressing the RFI spur using the notch filter.

Example 14. The apparatus of example 13, further including: a first summation circuit having an output and first and second inputs, the first input of the first summation circuit capable of receiving an initial sampling frequency of the transceiver and the second input of the first summation circuit capable of receiving a current sampling frequency of the transceiver; a multiplication circuit having an output and first and second inputs, the first input of the multiplication circuit coupled to the output of the first summation block, the second input of the multiplication circuit capable of receiving the bin; a gain circuit having an output and an input, the input of the gain circuit coupled to the output of the multiplication circuit, the gain circuit capable of applying a scaling factor to a signal received on the input of the gain circuit; and a second summation circuit having an output and first and second inputs, the first input of the second summation circuit coupled to the output of the gain circuit, the second input of the second summation circuit capable of receiving the bin, and the output of the second summation block capable of providing the updated bin.

Example 15. The apparatus of one of examples 13 or 14, where the transceiver is capable of characterizing the frequency drift by determining a difference between first and second sampling frequencies of a timing loop in the apparatus.

Example 16. The apparatus of one of examples 13 to 15, where the transceiver is capable of updating the bin based on a frequency band to which the RFI spur belongs.

Example 17. The apparatus of one of examples 13 to 16, where the transceiver is capable of determining the frequency band to which the RFI spur belongs by: determining a first RFI spur bin corresponding to a first sampling frequency of a timing loop in the transceiver; determining a second RFI spur bin corresponding to a second sampling frequency of the timing loop; determining a difference between the first and second RFI spur bins; and determining the frequency band to which the RFI spur belongs based on the difference.

Example 18. The apparatus of one of examples 13 to 17, where the transceiver is capable of determining the frequency band to which the RFI spur belongs by determining whether the difference between the first and second RFI spur bins exceeds a threshold and is positive or negative.

Example 19. The apparatus of one of examples 13 to 18, where the transceiver is capable of adding offsets to multiple bins across a frequency spectrum to reduce noise amplitude variation across the frequency spectrum.

Example 20. The apparatus of one of examples 13 to 19, where the transceiver is capable of identifying the RFI spur after adding the offsets.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A method comprising:
determining a bin corresponding to a radio frequency interference (RFI) spur in a signal, the bin based on a first sampling frequency of a timing loop in a receiver;
determining a shift of the first sampling frequency to a second sampling frequency;
updating the bin based on the shift;
setting a filter coefficient of a notch filter based on the updated bin;
suppressing the RFI spur using the notch filter; and
establishing link-up between the receiver and another device after suppressing the RFI spur.

2. The method of claim 1, wherein suppressing the RFI spur comprises suppressing the RFI spur during or prior to training the receiver.

3. The method of claim 1, further comprising detecting the RFI spur by applying a Fast Fourier transform to the signal.

4. The method of claim 1, wherein determining the bin includes applying a Fast Fourier transform to the signal.

5. The method of claim 1, further comprising detecting the RFI spur during an interval between an idle state and a training state.

6. The method of claim 1, further comprising adding an offset to reduce noise amplitude variation across a frequency spectrum and identifying the RFI spur after adding the offset.

7. The method of claim 1, further comprising performing a slicing operation on the signal.

8. The method of claim 1, wherein the receiver is an Ethernet receiver.

9. A method, comprising:
setting a timing loop of an receiver to a first sampling frequency;
determining a first bin of a first radio frequency interference (RFI) spur after setting the timing loop to the first sampling frequency;
setting the timing loop of the receiver to a second sampling frequency;
determining a second bin of a second RFI spur after setting the timing loop to the second sampling frequency;
determining a frequency band of the second RFI spur based on a difference between the first and second bins;
updating the second bin based on a shift in sampling frequency of the receiver;
setting a filter coefficient of a notch filter based on the updated second bin; and
suppressing the second RFI spur using the notch filter.

10. The method of claim 9, further comprising updating the second bin using an equation corresponding to the frequency band.

11. The method of claim 9, wherein determining the frequency band includes determining whether the difference is positive or negative and whether the difference exceeds a threshold.

12. The method of claim 9, wherein updating the second bin includes using a Fast Fourier transform (FFT) size.

13. An apparatus comprising:
a transceiver capable of:
determining a bin corresponding to a radio frequency interference (RFI) spur in a signal;
characterizing a frequency drift corresponding to the RFI spur;
updating the bin based on the characterization;
setting a filter coefficient of a notch filter based on the updated bin; and
suppressing the RFI spur using the notch filter.

14. The apparatus of claim 13, further comprising:
a first summation circuit having an output and first and second inputs, the first input of the first summation circuit capable of receiving an initial sampling frequency of the transceiver and the second input of the first summation circuit capable of receiving a current sampling frequency of the transceiver;
a multiplication circuit having an output and first and second inputs, the first input of the multiplication circuit coupled to the output of the first summation block, the second input of the multiplication circuit capable of receiving the bin;
a gain circuit having an output and an input, the input of the gain circuit coupled to the output of the multiplication circuit, the gain circuit capable of applying a scaling factor to a signal received on the input of the gain circuit; and
a second summation circuit having an output and first and second inputs, the first input of the second summation circuit coupled to the output of the gain circuit, the second input of the second summation circuit capable of receiving the bin, and the output of the second summation block capable of providing the updated bin.

15. The apparatus of claim 13, wherein the transceiver is capable of characterizing the frequency drift by determining a difference between first and second sampling frequencies of a timing loop in the apparatus.

16. The apparatus of claim 13, wherein the transceiver is capable of updating the bin based on a frequency band to which the RFI spur belongs.

17. The apparatus of claim 16, wherein the transceiver is capable of determining the frequency band to which the RFI spur belongs by:
determining a first RFI spur bin corresponding to a first sampling frequency of a timing loop in the transceiver;
determining a second RFI spur bin corresponding to a second sampling frequency of the timing loop;
determining a difference between the first and second RFI spur bins; and
determining the frequency band to which the RFI spur belongs based on the difference.

18. The apparatus of claim 16, wherein the transceiver is capable of determining the frequency band to which the RFI spur belongs by determining whether the difference between the first and second RFI spur bins exceeds a threshold and is positive or negative.

19. The apparatus of claim 13, wherein the transceiver is capable of adding offsets to multiple bins across a frequency spectrum to reduce noise amplitude variation across the frequency spectrum.

20. The apparatus of claim 19, wherein the transceiver is capable of identifying the RFI spur after adding the offsets.
